(19) United States
(12) Patent Application Publication
(10) Pub. No.: US 2005/0194506 A1
(43) Pub. Date: Sep. 8, 2005

(54) Cup holder and method of making a cup holder

(75) Inventors: Thomas Lang, Simmersfeld (DE); Bernd Plocher, Rottenburg (DE); Dirk Weisser, Ehningen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/063,619

(22) Filed: Feb. 24, 2005

(30) Foreign Application Priority Data
Feb. 25, 2004 (DE) 10 2004 009 111.0

(51) Int. Cl. F16M 11/00

(52) U.S. Cl. 248/311.2

(57) ABSTRACT

A cup holder includes a housing, a holding member having an opening, a connecting element, and a tray. When not in use, the holding member, the connecting element and the tray can be sunk in the housing, and can be extracted from the housing in the operative position. The tray can be arranged at a distance parallel to the holding member. One end of the connecting element is connected by way of a first swivel joint to the holding member, and the other end is pivot-connected to the tray by way of a second swivel joint. The second swivel joint is arranged at a distance from the center of mass of the tray so that the gravitational force produces a torque, by which the tray folds out.

This application claims the priority of German Patent Document No. 10 2004 009 111.0, filed Feb. 25, 2004, the disclosure of which is expressly incorporated by reference herein.

### BACKGROUND AND SUMMARY OF THE INVENTION

The invention relates to a cup holder for a motor vehicle and to a method of making a cup holder.

DE 199 59 260 A1 discloses a cup holder, which comprises a housing, a holding member and a supporting module, all of which are connected to swivel joints by means of a rotor and a thrust rod. The housing of the cup holder is installed obliquely; and the holding member, the supporting module, the rotor and the thrust rod can be sunk therein. In the course of an extraction movement, the holding member and the supporting member are moved into a horizontal position by means of the rotor and the thrust rod.

An object of the invention is to provide a cup holder, the construction of which is simple, with as few components as possible and which can be moved automatically from a non-operative position into an operative position.

The present invention achieves the object by providing a cup holder that includes a housing, a holding member having an opening, a connecting element, and a tray. When not in use, the holding member, the connecting element and the tray can be sunk in the housing, and can be extracted from the housing in the operative position. The tray can be arranged at a distance parallel to the holding member. One end of the connecting element is connected by way of a first swivel joint to the holding member, and the other end is pivot-connected to the tray by way of a second swivel joint. The second swivel joint is arranged at a distance from the center of mass of the tray so that the gravitational force produces a torque, by which the tray folds out.

A cup holder has a housing, a holding member with an opening for inserting liquid or beverage-containing containers, a connecting element and a tray for the liquid or beverage-containing containers. When not in use, the holding member, the connecting element and the tray are sunk in the housing for space saving reasons and are extracted for use. One end of the connecting element is connected by way of a first swivel joint to the holding member; and the other end is pivot-connected to the tray by way of a second swivel joint. The second swivel joint is arranged at a distance from the tray's center of mass so that in the operative position the gravitational force produces a torque, by way of which the tray folds out. This feature has the advantage that the cup holder automatically moves into its operative position without the need, for example, of a thrust rod. Thus, the number of requisite components is reduced; and the working reliability is increased.

The tray can also be unfolded into the operative position by way of a spring, which is braced against the swivel joint.

It is advantageous for the connecting element to have a stop, which limits the folding motion of the tray in such a manner that the tray can be swung only as far as an operative position parallel to the holding member. This feature prevents the tray from swinging beyond the operative position. Otherwise, before putting down a liquid or beverage-containing container, one had to also swivel the tray by hand.

According to a preferred embodiment, the connecting element includes a wedge, which is disposed between the connecting element and the tray and clamps the tray in the operative position. This feature has the advantage that in this way a safer and more stable operative position of the tray is achieved.

It is also advantageous for the holding member to have a recess, which is dimensioned in such a manner that the connecting element and the tray can be totally sunk into the holding member, because in this way a space saving arrangement of the cup holder is possible.

It is provided that the connecting element includes a lever with an approach slope, which, when slid in, makes contact with the housing in such a manner that the connecting element is swung upwardly. The advantage of this feature is that the swivel movement is automatic and no additional manipulations are necessary.

In another design the housing includes a spring with decreasing spring constant, which loads the holding member with a spring force in the opening direction. The course of the spring constant is dimensioned in such a manner that the spring force on the holding member is as excursion independent as possible. This feature has the advantage that the holding member moves out independently and, owing to the excursion-independent spring force, at constant speed.

Furthermore, it is provided that the second swivel joint is arranged in such a manner between the center of mass and an outer edge of the tray that the distance between the center of mass and the outer edge forms a lever, so that the outer edge makes contact with the holding member upon retraction of the holding member into the housing; and a torque for independent retraction of the tray into the housing is produced. This feature has the advantage that when pushed in, the tray swings automatically upward.

In another preferred embodiment the housing has a tooth rack, and the holding member has a gearwheel, both of which mesh with each other. The gearwheel is connected to a viscose brake for damping the retraction and extraction movement. In this way the retraction and extraction movements are braked; and the value expectation of the cup holder is increased.

To limit the extraction movement, the holding member has a stop, which strikes against the housing in the operative position.

In an especially preferred embodiment the stop can be sunk, preferably pushed in by hand, for the purpose of removing the holding member from the housing. This feature has the advantage that for cleaning, for example, the holding member and with it also the connecting element and the tray can be removed and thus are easy to clean.

Preferably the holding member has two side-by-side openings, for example, for the driver and the passenger, since in this way several liquid or beverage-containing containers can be placed into the openings and, therefore, can be held by the holding member.

Especially preferred are circular openings. Since the liquid-containing containers usually have a cylinder-like shape, the holding properties are, therefore, improved.

It is also advantageous for the opening of the holding member to have a rubber lip encircling the opening, because in this way the holding properties are further improved.

Other objects, advantages and novel features of the present invention will become apparent from the following detailed description of the invention when considered in conjunction with the accompanying drawings. One embodiment of the invention is described below and explained with reference to the drawings.

### BRIEF DESCRIPTION OF THE DRAWINGS

FIG. 1 is a perspective view of a cup holder.

FIG. 2 is a sectional view of the cup holder.

FIG. 3 is a detailed view of a connecting region between the connecting element and the tray.

### DETAILED DESCRIPTION OF THE DRAWINGS

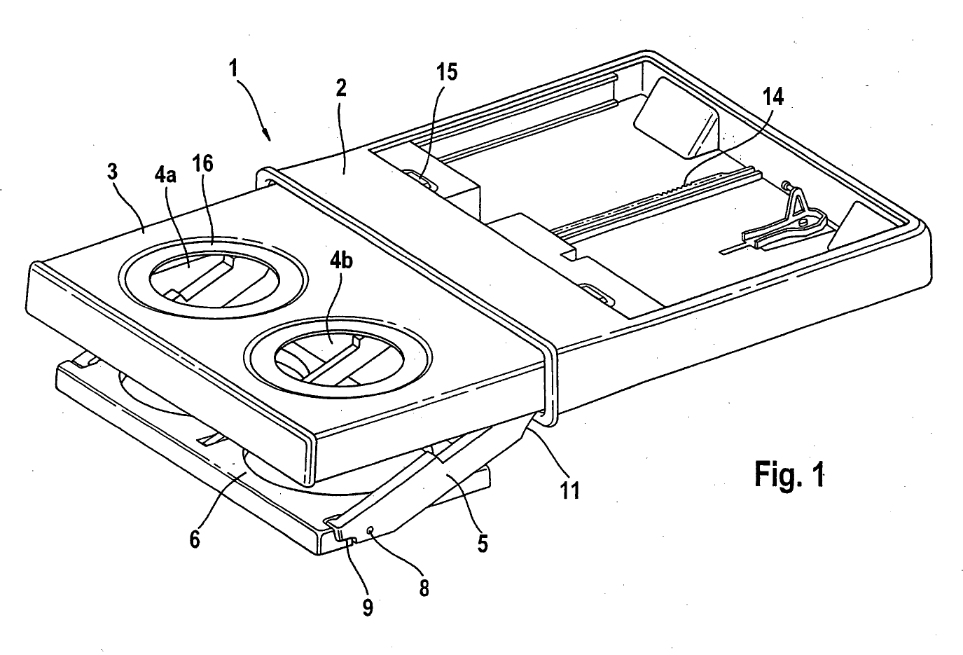

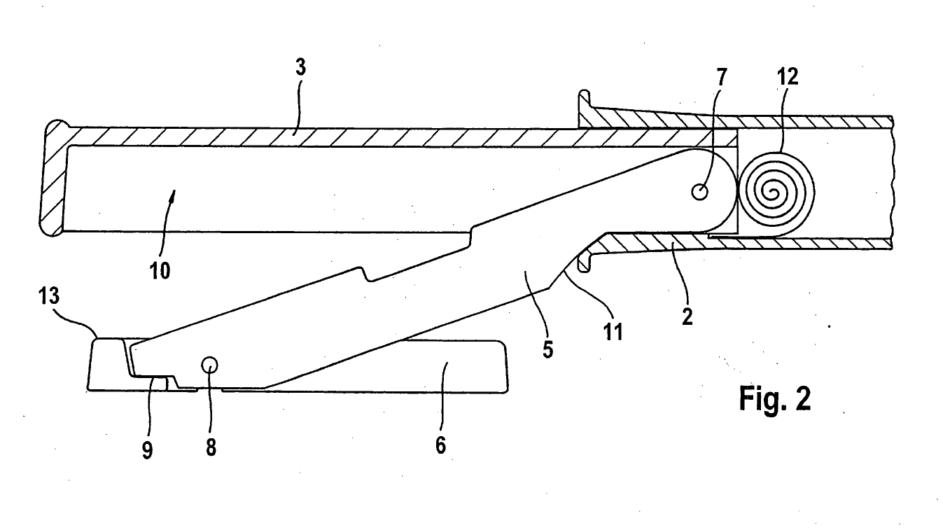

FIG. 1 is a perspective view of a cup holder 1. The cup holder 1 has a housing 2, a holding member 3, with openings 4, a connecting element 5, and a tray 6. The cup holder 1 is shown in the extracted operative position. The connecting element 5 connects the holding member 3 and the tray 6, and is swung downward into an inclined position. One end of the connecting element is connected to the holding member 3 by way of a first swivel joint 7, which is shown in detail in FIG. 2. The other end of the connecting element 5 is connected to the swivelable tray 6 by way of a second swivel joint 8. The second swivel joint 8 is located at a distance from the center of mass of the tray 6. The gravitational force and the distance from the center of mass, which forms a lever arm, produce a torque that acts on the tray 6 and swivels said tray. In the extracted position the tray 6 is located in a horizontal position. The swivel movement of the tray is defined in such a manner by a stop 9 at the connecting element 5 that a position, parallel to the holding member 3, is reached.

The one end of the connecting element 5 has an approach slope 11. In the extracted operative position this approach slope 11 is in contact with the housing 2 and defines thus the downward movement of the connecting element 5. Furthermore, said approach slope is designed in such a manner that during a slide-in movement a force is exerted at the contact point on the connecting element 5; and the connecting element 5 is swiveled, in accordance with the shape of the approach slopes 11, upward into the holding member 3. The position of the contact points migrates, in accordance with the slide-in position, along the approach slope 11. The approach slope 11 is configured in such a manner that in the course of the slide-in movement as soon as the position of the contact point reaches the one end of the approach slope 11, the connecting element 5 reaches a horizontal position.

Behind the holding member 3 there is in the housing 2 a constant force spring 12, which is shown in detail in FIG. 2. The constant force spring loads the holding member 3 with a spring force in the slide-out direction.

The lower inside of the housing 2 has a tooth rack 14, which meshes with a gearwheel, which is arranged on the underside of the holding member 3. The gearwheel is connected to a viscose brake. The retraction and extraction movement is damped; and an appreciative impression is made.

In the operative position shown in FIG. 1, a stop 15, which is disposed on the holding member 3, makes contact with the housing 2. This stop 15 defines the extraction movement of the holding member 3. The stop 15 on the holding member 3 can be sunk, preferably pushed in by hand. In this way the holding member 3 can be extracted even further and thus can be removed from the housing, for example, for cleaning.

The opening 4 has a circular rubber lip 16. The rubber lip 16 enables an adaptation to liquid or beverage-containing containers of varying dimensions. Even liquid or beverage-containing containers having different diameters, in particular undercuts, can be held securely in this way.

FIG. 2 is a sectional view of the cup holder 1. The underside of the holding member 3 has a recess 10. The recess 10 is designed in such a manner that the connecting element 5 and the tray 6 can be completely sunk or received therein.

The constant force spring 12 is disposed behind the holding member 3 in the housing 2. This constant force spring 12 loads the holding member 3 with a force in the extraction direction. The constant force spring 12 is by construction similar to a spiral spring, which is used, for example, as a driving spring in clocks. The difference between the spiral spring and the constant force spring is that in the case of the constant force spring 12 the two ends are not clamped. The inner end can move freely.

The outer end of the constant force spring 12 is rigidly connected to the housing 2. As soon as the holding member 3 is slid into the housing 2, the constant force spring 12 is unrolled. Owing to its construction, the constant force spring 12 is always endeavoring to return into the rolled up state. The resulting force causes the holding member 3 to slide out independently.

The course of the spring constant of the constant force spring 12 is dimensioned in such a manner that the spring force is as independent of the spring excursion as possible. Thus, the spring force is virtually constant during the entire extraction movement.

For the purpose of an advantageous retraction of the tray 6, the connecting element is connected to the tray 6 by way of the second swivel joint 8 between the center of mass and the outer edge 13 of the tray 6 in such a manner that the distance between the center of mass and the outer edge 13 forms a lever. For an independent retraction of the tray 6 into the housing, the outer edge 13 makes contact with the inside of the holding member 3; and a torque is produced so that the tray 6 swings upwardly into the recess of the holding member.

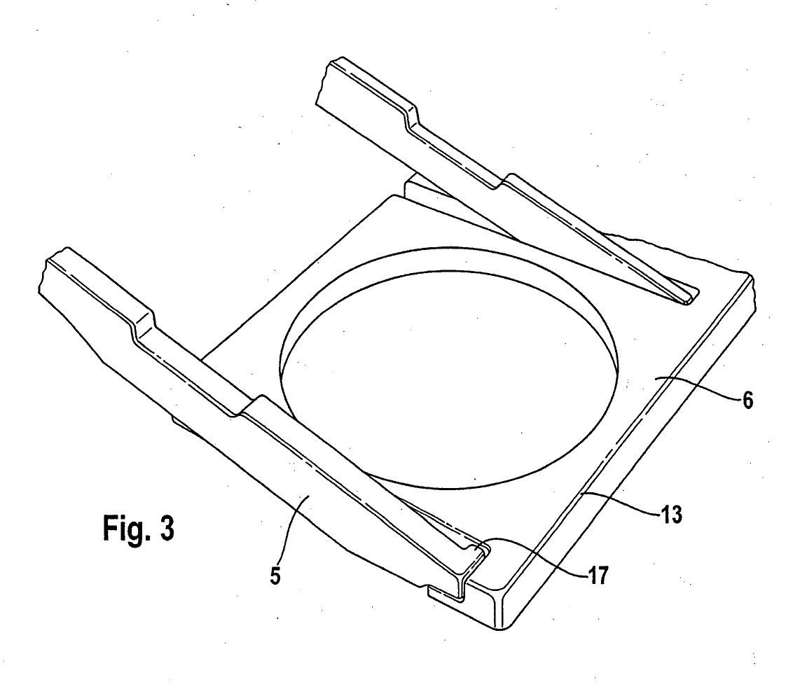

FIG. 3 is a detailed view of a connecting area between the connecting element 5 and the tray 6. The front end of the connecting element 5 has a wedge 17, which is disposed in a gap between the connecting element and the tray. The tray is clamped by the wedge 17 in the operative position, thus achieving a safe and stable operative position.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A cup holder comprising:
a housing;
a holding member having an opening;
a connecting element; and
a tray, wherein, when not in use, the holding member, the connecting element and the tray can be sunk in the housing and in the operative position can be extracted from the housing, wherein the tray can be arranged at a distance parallel to the holding member, wherein one end of the connecting element is connected by way of a first swivel joint to the holding member, and the other end is pivot-connected to the tray by way of a second swivel joint, the second swivel joint being arranged at a distance from the center of mass of the tray so that the gravitational force produces a torque, by which the tray folds out.

2. The cup holder of claim 1, wherein the connecting element has a stop, which defines the folding motion of the tray in such a manner that the tray can be swung only as far as an operative position parallel to the holding member.

3. The cup holder of claim 2, wherein the connecting element has a wedge, which clamps the tray in the operative position.

4. The cup holder of claim 3, wherein the holding member has a recess, which is dimensioned in such a manner that the connecting element and the tray can be completely sunk into the recess.

5. The cup holder of claim 4, wherein the connecting element has a lever with an approach slope, which, when slid in, makes contact with the housing in such a manner that the connecting element is swung upwardly.

6. The cup holder of claim 5, wherein the housing includes a spring with decreasing spring constant, which loads the holding member with an independent spring force in the opening direction.

7. The cup holder of claim 6, wherein the spring is a constant force spring.

8. The cup holder of claim 7, wherein the second swivel joint is arranged in such a manner between the center of mass and an outer edge of the tray that the distance between the center of mass and the outer edge forms a lever, so that the outer edge makes contact with the holding member upon retraction of the holding member into the housing, and a torque for independent retraction of the tray into the housing is produced.

9. The cup holder of claim 8, wherein the housing includes a tooth rack and wherein the holding member includes a gearwheel, the rack and gearwheel meshing with each other, the gearwheel being connected to a viscose brake for damping the retraction and extraction movement.

10. The cup holder of claim 9, wherein the holding member has a stop, which strikes against the housing in the operative state and thus limits the extraction movement.

11. The cup holder of claim 10, wherein the stop can be sunk, for the purpose of removing the holding member from the housing.

12. The cup holder of claim 11, wherein the holding member has two side-by-side openings.

13. The cup holder of claim 12, wherein at least one of the openings is circular.

14. The cup holder of claim 13, wherein at least one of the openings of the holding member has a rubber lip encircling the opening.

15. The cup holder of claim 14, wherein the tray is a drip protector.

16. The cup holder of claim 1, wherein the connecting element has a wedge, which clamps the tray in the operative position.

17. The cup holder of claim 1, wherein the holding member has a recess, which is dimensioned in such a manner that the connecting element and the tray can be completely sunk into the recess.

18. The cup holder of claim 1, wherein the connecting element has a lever with an approach slope, which, when slid in, makes contact with the housing in such a manner that the connecting element is swung upwardly.

19. The cup holder of claim 1, wherein the housing includes a spring with decreasing spring constant, which loads the holding member with an independent spring force in the opening direction.

20. The cup holder of claim 6, wherein the spring is a constant force spring.

21. The cup holder of claim 1, wherein the second swivel joint is arranged in such a manner between the center of mass and an outer edge of the tray that the distance between the center of mass and the outer edge forms a lever, so that the outer edge makes contact with the holding member upon retraction of the holding member into the housing, and a torque for independent retraction of the tray into the housing is produced.

22. The cup holder of claim 1, wherein the housing includes a tooth rack and wherein the holding member includes a gearwheel, the rack and gearwheel meshing with each other, the gearwheel being connected to a viscose brake for damping the retraction and extraction movement.

23. The cup holder of claim 1, wherein the holding member has a stop, which strikes against the housing in the operative state and thus limits the extraction movement.

24. The cup holder of claim 10, wherein the stop can be sunk, for the purpose of removing the holding member from the housing.

25. The cup holder of claim 1, wherein the holding member has two side-by-side openings.

26. The cup holder of claim 1, wherein at least one of the openings is circular.

27. The cup holder of claim 1, wherein at least one of the openings of the holding member has a rubber lip encircling the opening.

28. The cup holder of claim 1, wherein the tray is a drip protector.

29. A method of making a cup holder, comprising the steps of:
allowing a holding member, connecting element and tray of the cup holder to sink in a housing of the cup holder when the cup holder is not in use;
allowing the holding member, connecting element and tray to extract from the housing when the cup holder is not in use;
pivotably connecting one end of the connecting element, by way of a first swivel joint, to the holding member;
pivotably connecting the other end of the connecting element to the tray by way of a second swivel joint;
arranging the second swivel joint at a distance from the center of mass of the tray so that the gravitational force produces a torque, by which the tray folds out.
